(19) United States
(12) Patent Application Publication
(10) Pub. No.: US 2020/0079607 A1
(43) Pub. Date: Mar. 12, 2020

(54) SHEET CONVEYING DEVICE AND IMAGE READING DEVICE INCLUDING THE SAME

(71) Applicant: KYOCERA Document Solutions Inc., Osaka (JP)

(72) Inventor: Shinichi TAJIMA, Osaka (JP)

(21) Appl. No.: 16/561,100

(22) Filed: Sep. 5, 2019

(30) Foreign Application Priority Data
Sep. 7, 2018 (JP) 2018-167647

(51) Int. Cl. B65H 7/12; G03G 15/00; G03G 21/16

(52) U.S. Cl. CPC B65H 7/12; G03G 15/6532; G03G 2215/00548; G03G 21/1633; G03G 21/1661; G03G 15/703

(57) ABSTRACT

A sheet conveying device includes a control unit. The control unit determines whether a first sheet and a second sheet being double-fed are in a full double feed state in which the first sheet and the second sheet are conveyed while overlapping each other from distal end parts of the first sheet and the second sheet in a conveyance direction or a partial double feed state in which the second sheet is conveyed while overlapping a rear part of the first sheet than the distal end part of the first sheet, stops an operation of a sheet conveying mechanism when it is determined that the sheets are in the full double feed state, and performs double feed elimination control for eliminating the double feeding of the sheets without stopping the sheet conveying mechanism when it is determined that the sheets are in the partial double feed state.

### CROSS-REFERENCE TO RELATED APPLICATION

This application is based upon and claims the benefit of priority from Japanese Patent Application No. 2018-167647 filed on Sep. 7, 2018, the entire contents of which are incorporated herein by reference.

### BACKGROUND

The technology of the present disclosure relates to a sheet conveying device and an image reading device including the same.

An image reading device such as an image scanner may be provided with a document conveying device for continuously supplying a document sheet (an example of a sheet) to an image reading position. The document conveying device separates document sheets set on a sheet feeding tray one by one, conveys the separated document sheets along a conveyance path in which the image reading position is set, and then discharges the separated document sheets to a discharge tray.

This type of document conveying device is usually provided with a double feed detection sensor for detecting double feeding of document sheets. The double feed detection sensor is connected to a control unit. When it is determined based on a signal from the double feed detection sensor that double feed is occurring, the control unit stops document sheet conveyance and displays an error. However, the document conveying device has a problem that the reading efficiency of an image is poor because the document sheet conveyance is stopped every time the double feed occurs.

In this regard, a document conveying device capable of solving such a problem has been proposed. The document conveying device is configured to continue a reading operation without stopping sheet conveyance even when double feeding of document sheets has occurred and collect only document sheets with failure in reading due to the double feeding after all document sheets are discharged to the discharge tray.

### SUMMARY

A sheet conveying device according to one aspect of the technology of the present disclosure includes a conveying mechanism and a double feed detection sensor. The conveying mechanism conveys sheets along a sheet conveyance path. The double feed detection sensor is provided at a double feed detection position set in the sheet conveyance path and outputs a signal for detecting double feeding of the sheets.

Furthermore, the sheet conveying device includes a double feed determination unit, a double feed state determination unit, and a control unit. The double feed determination unit determines whether the double feeding of the sheets is occurring based on the signal of the double feed detection sensor. The double feed state determination unit determines whether the sheets are in a full double feed state or a partial double feed state when the double feed determination unit determines that the double feeding is occurring.

The full double feed state is a state in which a first sheet and a second sheet being double-fed are conveyed while overlapping each other from distal end parts of the first sheet and the second sheet in a conveyance direction. The partial double feed state is a state in which the second sheet is conveyed while overlapping a rear part of the first sheet than the distal end part of the first sheet in the conveyance direction.

The control unit stops an operation of the conveying mechanism when the double feed state determination unit determines that the first sheet and the second sheet are in the full double feed state, and performs double feed elimination control when the double feed state determination unit determines that the first sheet and the second sheet are in the partial double feed state. The double feed elimination control is control for eliminating the double feeding of the first sheet and the second sheet while continuing the operation of the conveying mechanism.

An image reading device according to another aspect of the technology of the present disclosure includes the aforementioned sheet conveying device.

### BRIEF DESCRIPTION OF THE DRAWINGS

FIG. 1 is an overall schematic view illustrating an image forming apparatus provided with a document conveying device (an example of a sheet conveying device) in an embodiment.

FIG. 2 is a longitudinal sectional view illustrating a schematic configuration of the document conveying device.

FIG. 3 is an enlarged schematic view of a part III of FIG. 2.

FIG. 4 is a schematic view illustrating a state in which document sheets are conveyed in a full double feed state.

FIG. 5 is a schematic view illustrating a state in which document sheets are conveyed in a partial double feed state.

FIG. 6A to FIG. 6D are explanation views for explaining details of double feed elimination control performed by a control unit.

### DETAILED DESCRIPTION

Hereinafter, an example of an embodiment will be described in detail on the basis of the drawings. It is noted that the technology of the present disclosure is not limited to the following embodiments.

### Embodiment

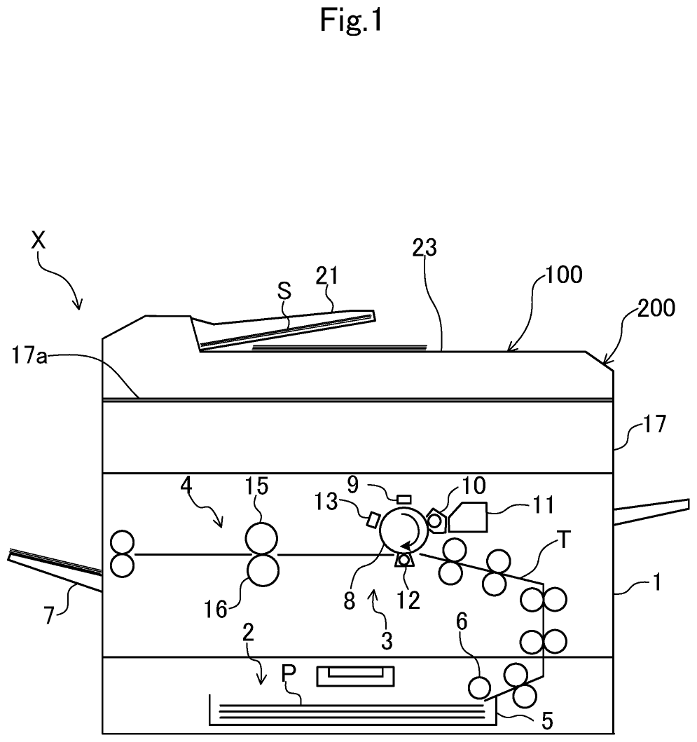

FIG. 1 illustrates an image forming apparatus X provided with an image reading device 200 having a document conveying device 100 (an example of a sheet conveying device) in an embodiment. The image forming apparatus X is a copy machine that prints a document image read by the image reading device 200. It is noted that the image forming apparatus X is not limited to the copy machine and may be a facsimile, a multifunctional peripheral (MFP) capable of performing a plurality of types of jobs, or the like.

The image forming apparatus X has an image forming apparatus body 1 having a rectangular box shape in appearance and the image reading device 200 is disposed on an upper side of the image forming apparatus body 1.

The image forming apparatus body 1 has a sheet feeding unit 2, an image forming unit 3, and a fixing unit 4. The sheet feeding unit 2 has a sheet feeding cassette 5 that stores a plurality of printing sheets P stacked in a bundle shape and a pickup roller 6 that takes out the printing sheets P in the sheet feeding cassette 5 one by one and supplies the taken-out printing sheets P to a predetermined sheet conveyance path T. The sheet conveyance path T extends upward from the sheet feeding unit 2, extends in a horizontal direction, and then is connected to a document discharge tray 7.

The image forming unit 3 is provided with a photosensitive drum 8, a charging device 9, a developing device 10, a toner container 11, a transfer roller 12, and a charge eliminating device 13. Furthermore, the image forming unit 3 forms an image on the printing sheet P supplied from the sheet feeding unit 2 according to the following procedure.

Specifically, first, the charging device 9 charges the photosensitive drum 8 to a predetermined potential. Next, light based on image data is irradiated on the surface of the photosensitive drum 8 by a laser scanning unit (LSU; not illustrated). In this way, an electrostatic latent image is formed on the surface of the photosensitive drum 8.

Then, the developing device 10 supplies toner to the electrostatic latent image on the photosensitive drum 8 and develops the electrostatic latent image. The transfer roller 12 rotates while being brought into press-contact with the surface of the photosensitive drum 8 with the printing sheet P interposed therebetween. In such a case, since a transfer voltage is applied to the transfer roller 12, a toner image on the surface of the photosensitive drum 8 is transferred to the printing sheet P. The charge eliminating device 13 eliminates the charge on the surface of the photosensitive drum 8 after the toner image is transferred to the printing sheet P.

The fixing unit 4 has a fixing roller 15 and a pressure roller 16 that are brought into press-contact with each other. The fixing roller 15 has a heater therein. The fixing unit 4 heats and presses the toner image while interposing and conveying the printing sheet P by the fixing roller 15 and the pressure roller 16, thereby fixing the toner image to the printing sheet P.

The image reading device 200 has an image reading unit 17 placed on the upper side of the image forming apparatus body 1, and the document conveying device 100 mounted on an upper surface of the image reading unit 17.

The image reading unit 17 has a rectangular box shape in appearance. A contact glass 17a is mounted on an upper surface of a scanner case constituting an outer wall of the image reading unit 17. The image reading unit 17 has a light source, a reflection mirror, an image sensor or the like.

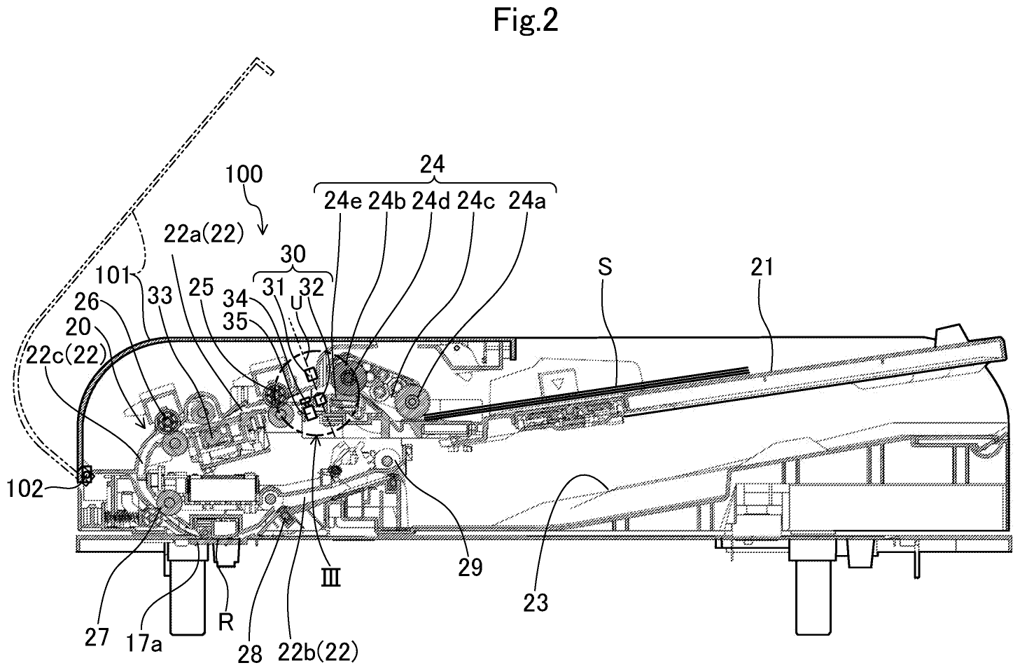

Furthermore, the image reading unit 17 reads an image of a document sheet S by either a sheet fixing scheme or a sheet-through scheme. In a read operation by the sheet fixing scheme, the image reading unit 17 allows the light source to emit light toward the document sheet S placed on the contact glass 17a. On the other hand, in a read operation by the sheet-through scheme, the image reading unit 17 allows the light source to emit light toward the document sheet S supplied from the document conveying device 100 to an image reading position R (see FIG. 2) on the contact glass 17a. The image reading unit 17 reads an image on one side surface of the document sheet S by reading reflected light from the document sheet S by the image sensor, thereby generating image data thereof.

It is noted that in the read operation by the sheet-through scheme, an image on the other side surface of the document sheet S is read by a contact image sensor 33 to be described below, so that it is possible to read both sides of the document sheet S. The contact image sensor 33 is provided in the document conveying device 100.

[Configuration of Document Conveying Device]

As illustrated in FIG. 2, the document conveying device 100 has a document set tray 21, a sheet conveyance path 22, and a document discharge tray 23. A plurality of types of document sheets S having different width sizes (for example, A4 size, A6 size or the like) can be set on the document set tray 21.

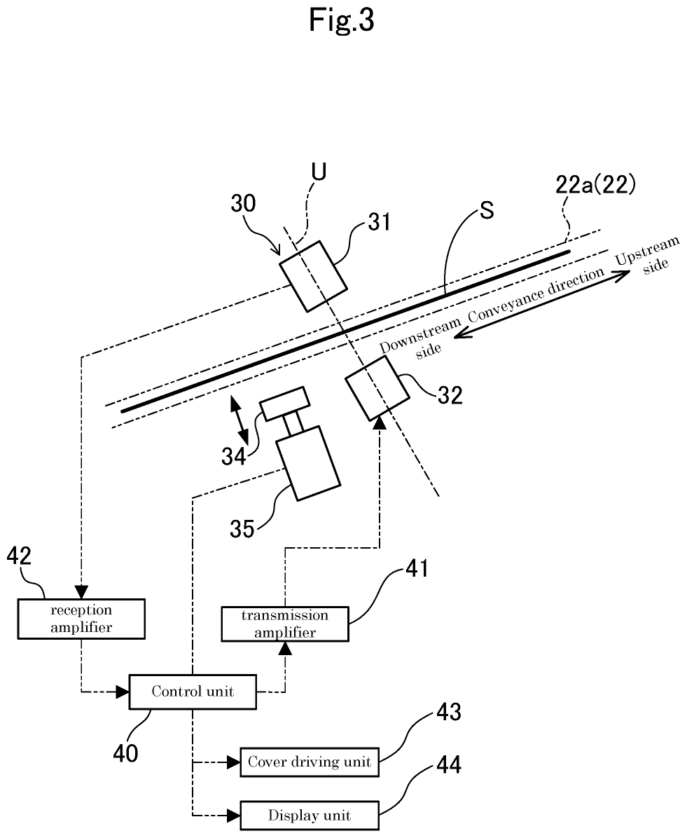

The sheet conveyance path 22 is provided at the left end of the document conveying device 100 in FIG. 2. The left end of the document conveying device 100 is covered by an outer cover 101 so as to be openable and closable. The outer cover 101 is manually opened or automatically opened by a cover driving unit 43 (see FIG. 3) to be described below.

The document conveying device 100 supplies the document sheets S placed on the document set tray 21 to the sheet conveyance path 22 by a conveying mechanism 20 and discharges the document sheets S to the document discharge tray 23 via the sheet conveyance path 22.

Furthermore, the image reading position R is set at a position in the middle of the sheet conveyance path 22. Immediately below the image reading position R, the image reading unit (not illustrated) stands by with the contact glass 17a interposed therebetween, and the image on one side surface of the document sheet S (a surface directed upward when the document sheets S are set on the document set tray 21) is read by the image reading unit. Furthermore, the contact image sensor 33 is provided on an upstream side with respect to the image reading position R in the sheet conveyance path 22 to read the image on the other side surface of the document sheet S (a surface opposite to the one side surface and directed downward when the document sheets S are set on the document set tray 21).

The sheet conveyance path 22 is an approximately U-shaped conveyance path from an end of the document set tray 21 on a conveyance downstream side to an end of the document discharge tray 7 on a conveyance upstream side. Specifically, the sheet conveyance path 22 has an upstream side conveyance path 22a, a downstream side conveyance path 22b, and an intermediate conveyance path 22c that connects both the conveyance paths 22a and 22b.

The upstream side conveyance path 22a is inclined to be positioned on the lower side toward the downstream side in the conveyance direction. The downstream side conveyance path 22b is inclined to be positioned on the upper side toward the downstream side in the conveyance direction. The intermediate conveyance path 22c is an approximately arc-shaped curved conveyance path having one end connected to has the upstream side conveyance path 22a and the other end connected to the downstream side conveyance path 22b.

The conveying mechanism 20 has a sheet feeding unit 24, a resist roller pair 25, a conveying roller pair 26, a conveying roller pair 27, a conveying roller pair 28, and a discharge roller pair 29, which are disposed in order from the upstream side to the downstream side of the sheet conveyance path 22.

The sheet feeding unit 24 takes out the document sheets S placed on the document set tray 21, advances the taken-out document sheets S in the conveyance direction, and supplies the taken-out document sheets S to the sheet conveyance path 22. Specifically, the sheet feeding unit 24 has a delivery roller 24a that takes out the document sheets S placed on the document set tray 21, and a feeding roller 24b supplies the sheet conveyance path 22 with the document sheets S taken out from the document set tray 21 by the delivery roller 24a.

The delivery roller 24a and the feeding roller 24b are connected to each other by an arm member 24c. A base end of the arm member 24c is rotatably supported to a roller shaft 24d of the feeding roller 24b.

The delivery roller 24a is supported to a distal end part of the arm member 24c. Furthermore, as the arm member 24c rotates about the roller shaft 24d in the clockwise direction of FIG. 2, the delivery roller 24a moves down to abut the upper surface of the bundled document sheets S on the document set tray 21.

A separation pad 24e is provided below the feeding roller 24b. The separation pad 24e is brought into press-contact with a peripheral surface of the feeding roller 24b to form a nip part. A frictional coefficient between the feeding roller 24b and the document sheet S is set to be larger than that of the separation pad 24e and the document sheet S, and when there is one document sheet S passing through the nip part, the document sheet S is conveyed to the downstream side by the feeding roller 24b. On the other hand, the frictional coefficient between the separation pad 24e and the document sheet S is set to be larger than that of the document sheets S. Therefore, when sheets passing through the nip part are in a double feed state, an upper document sheet S is conveyed to the downstream side but a lower document sheet S is not conveyed. Thus, the double feed sheets can be separated by the feeding roller 24b and the separation pad 24e one by one and sent to the downstream side. However, when frictional coupling force between the document sheets S is strong, the document sheets S are conveyed to the downstream side in the double feed state.

The resist roller pair 25 temporarily stops the conveyance of the document sheets S supplied to the sheet conveyance path 22 and bends the document sheets S, thereby correcting a skew of the document sheets S. That is, the resist roller pair 25 does not rotate when a distal end of the document sheet S has reached and starts to rotate after the distal end of the document sheet S reaches.

The conveying roller pairs 26 to 28 convey the document sheets S supplied to the sheet conveyance path 22 by the sheet feeding unit 24. Furthermore, the discharge roller pair 29 discharges the document sheets S, which have been conveyed to the end of the sheet conveyance path 22 on the downstream side by the conveying roller pairs 26 to 28, to the document discharge tray 23.

Between the feeding roller 24b and the resist roller pair 25, a double feed detection sensor 30 is provided. The double feed detection sensor 30 outputs a signal for detecting whether the document sheets S passing through a double feed detection position U are being double-fed. The signal outputted from the double feed detection sensor 30 is transmitted to a control unit 40 (see FIG. 3). In the vicinity of the double feed detection sensor 30 on the downstream side, a separation pad 34 (corresponding to a separation member) is provided to eliminate the double feeding of the document sheets S. The separation pad 34 is used in double feed elimination control to be described below.

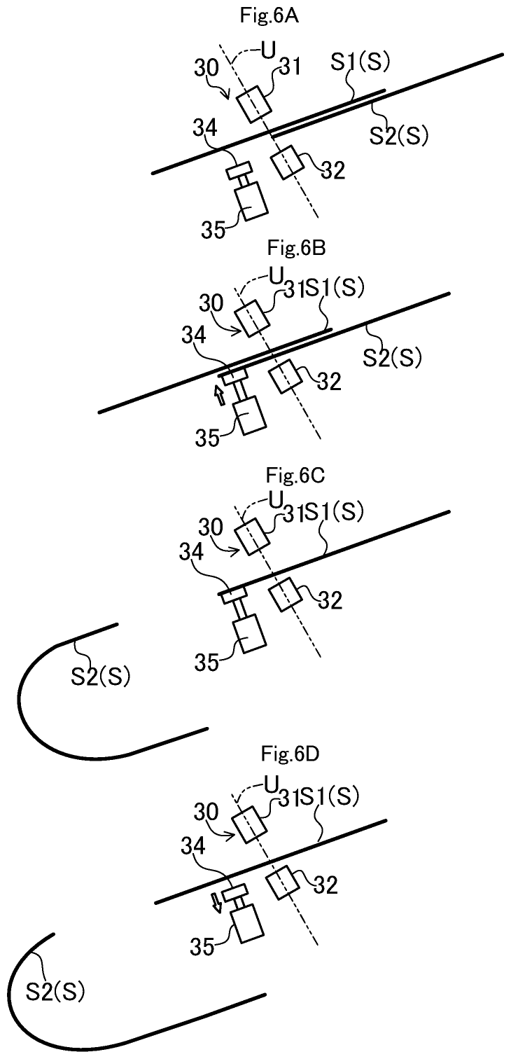

The separation pad 34 is driven between a standby position and a separation position by a driving actuator 35. The standby position is a position where the separation pad 34 is separated from the sheet conveyance path 22 and does not contact with the document sheet S passing through the sheet conveyance path 22 as illustrated in FIG. 3. The separation position is a position (see FIG. 6B) where the separation pad 34 contacts with the document sheet S passing through the sheet conveyance path 22. The driving actuator 35, for example, is composed of a direct-acting electromagnetic solenoid. The driving actuator 35 is controlled by the control unit 40. A frictional coefficient between the separation pad 34 and the document sheet S is larger than that of the document sheets S. The separation pad 34, for example, is composed of a rubber member or the like.

The control unit 40 includes a microcomputer having a CPU, a ROM, and a RAM. The control unit 40 is connected to the double feed detection sensor 30 via a signal line. When the double feeding of the document sheets S is not detected based on the signal from the double feed detection sensor 30, the control unit 40 continues the conveyance of the document sheets S.

On the other hand, when the double feeding of the document sheets S is detected, the control unit 40 selectively performs conveyance stop control of the document sheets S or separation control of the document sheets S. Details of the control process (conveyance stop control or double feed elimination control) of the control unit 40 at the time of the double feed detection will be described below.

[Configuration of Double Feed Detection Sensor]

Next, with reference to FIG. 2 and FIG. 3, a schematic configuration of the double feed detection sensor 30 will be described. The double feed detection sensor 30 is composed of an ultrasonic sensor. Specifically, the double feed detection sensor 30 has an upper ultrasonic vibrator 31 and a lower ultrasonic vibrator 32 disposed on an upper side and a lower side of the sheet conveyance path 22, respectively. Both the ultrasonic vibrators 31 and 32 are disposed opposite to each other with the sheet conveyance path 22 interposed therebetween.

As illustrated in FIG. 3, the upper ultrasonic vibrator 31 is connected to the control unit 40 via a reception amplifier 42, and the lower ultrasonic vibrator 32 is connected to the control unit 40 via a transmission amplifier 41.

When the ultrasonic sensor (the double feed detection sensor 30) is driven, the control unit 40 outputs a pulse-shaped transmission control signal to the transmission amplifier 41. The transmission amplifier 41 amplifies the transmission control signal outputted from the control unit 40 and applies a sinusoidal AC voltage to the lower ultrasonic vibrator 32. In this way, the lower ultrasonic vibrator 32 vibrates at a predetermined frequency and ultrasonic waves are transmitted from the lower ultrasonic vibrator 32. The ultrasonic waves transmitted from the lower ultrasonic vibrator 32 are propagated to the upper ultrasonic vibrator 31 using air as a medium. The upper ultrasonic vibrator 31 receives the ultrasonic waves from the lower ultrasonic vibrator 32 and generates a waveform signal thereof.

The reception amplifier 42 amplifies the waveform signal and transmits the amplified waveform signal to the control unit 40. The control unit 40 determines the attenuation amount (a change amount of an amplitude) of the ultrasonic waves between the lower ultrasonic vibrator 32 and the upper ultrasonic vibrator 31 based on the waveform signal from the reception amplifier 42. When the attenuation amount of the ultrasonic waves exceeds a predetermined value, the control unit 40 detects that the double feeding of the document sheets S is occurring. This double feed detection process uses the property that the attenuation amount of the ultrasonic waves increases as the number of overlapping document sheets S passing through between both the ultrasonic vibrators 31 and 32 increases. The control unit 40 serves as a double feed determination unit.

[Details of Control Process at the Time of Double Feed Detection]

When the double feeding of the document sheets S is detected, the control unit 40 determines whether the double feed state of the document sheets S is in a full double feed state or a partial double feed state.

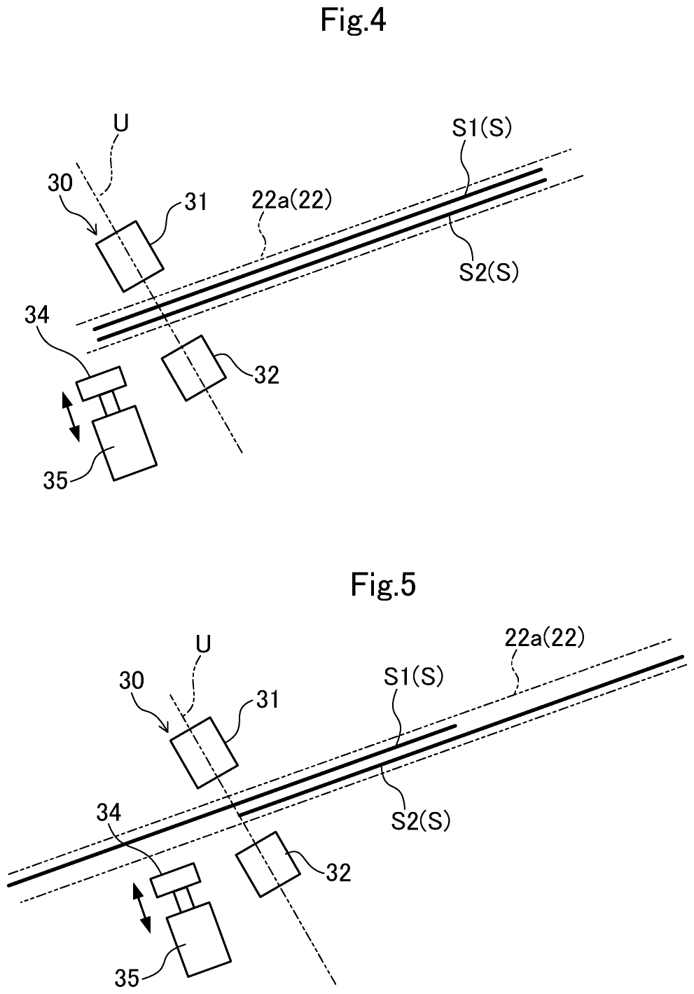

The full double feed state is a state in which a first sheet S1 and a second sheet S2 being double-fed are conveyed while overlapping each other from distal end parts thereof in the conveyance direction as illustrated in FIG. 4. On the other hand, the partial double feed state is a state in which the second sheet S2 is conveyed while overlapping a rear part of the first sheet S1, than a distal end part thereof, in the conveyance direction as illustrated in FIG. 5. The partial double feed state is a state in which frictional coupling force between the first sheet S1 and the second sheet S2 is weaker than that in the full double feed state and thus both the sheets S1 and S2 are easily separated.

When the level of the signal received from the upper ultrasonic vibrator 31 via the reception amplifier 42 is changed at once from a level without any sheet to a double feed level, the control unit 40 determines that the document sheets S are in the full double feed state (the state of FIG. 4). On the other hand, when the level of the signal from the reception amplifier 42 is changed from the level without any sheet to a passage level of one sheet and then is changed to the double feed level, the control unit 40 determines that the document sheets S are in the partial double feed state (the state of FIG. 5). By so doing, the control unit 40 serves as a double feed state determination unit.

When it is determined that the document sheets S are in the full double feed state, the control unit 40 performs the conveyance stop control for stopping the conveyance of the document sheets S by outputting a stop signal to a driving motor (not illustrated) of the conveying mechanism 20. Furthermore, when it is determined that the document sheets S are in the full double feed state, the control unit 40 opens the outer cover 101 by the cover driving unit 43 and displays an error on a display unit 44. The two dot chain line of FIG. 2 indicates a state in which the outer cover 101 is opened by the cover driving unit 43. The cover driving unit 43 is composed of a motor or the like that rotate the outer cover 101 around a shaft 102.

On the other hand, when it is determined that the document sheets S are in the partial double feed state, the control unit 40 performs the double feed elimination control for separating both the sheets S1 and S2 from each other by pressing the separation pad 34 against the second sheet S2.

With reference to FIG. 6A to FIG. 6D, details of the double feed elimination control will be described.

FIG. 6A illustrates a state in which the second sheet S2 partially overlapping the first sheet S1 has reached the double feed detection position U. In such a state, the control unit 40 detects that the document sheets S1 and S2 are in the partial double feed state based on the signal level from the reception amplifier 42.

When the second sheet S2 has passed through above the separation pad 34, the control unit 40 moves the separation pad 34 from the standby position to the separation position by the driving actuator 35. In this way, as illustrated in FIG. 6B, the separation pad 34 is pressed against the second sheet S2.

By so doing, as illustrated in FIG. 6C, since frictional force is applied to the second sheet S2 by the separation pad 34, only the first sheet S1 is separated from the second sheet S2 and is conveyed to the downstream side. The second sheet S2 waits at a predetermined position while being pressed by the separation pad 34.

Then, as illustrated in FIG. 6D, at a timing at which an interval between the second sheet S2 and the first sheet S1 has reached a predetermined value, the separation pad 34 is returned to the standby position by the driving actuator 35 and the supply and conveyance of the second sheet S2 is performed by the resist roller pair 25.

[Operation Effects]

As described above, in the present embodiment, the control unit 40 determines whether the first sheet S1 and the second sheet S2 being double-fed are in the full double feed state or the partial double feed state, stops the overall operation of the conveying mechanism 20 when it is determined that they are in the full double feed state, and performs the double feed elimination control for eliminating the double feeding of the sheets while continuing the operation of the conveying mechanism 20 when it is determined that they are in the partial double feed state.

According to this, even when the double feeding of the document sheet S has occurred, in a state in which frictional force between the sheets S1 and S2 is relatively weak as in the partial double feed state, the conveyance operation of the document sheets S by the conveying mechanism 20 does not stop. Thus, it is possible to improve the reading efficiency of the document sheets S as compared with a case where the overall operation of the conveying mechanism 20 is stopped whenever the double feed occurs. Furthermore, at the time of the occurrence of the full double feed state in which it is not possible to eliminate the double feed even though the double feed elimination control is performed, since the operation of the conveying mechanism 20 is stopped, double feed sheets are not damaged by forcible conveyance of the conveying mechanism 20.

Furthermore, the double feed elimination control is performed by bring the separation pad 34 having high frictional force into contact with one document sheet S (the second sheet S2 in the aforementioned embodiment) by the driving actuator 35. According to this, it is possible to eliminate the double feed with a simple configuration.

Furthermore, when it is determined that the first sheet S1 and the second sheet S2 being double-fed are in the full double feed state, the control unit 40 drives the cover driving unit 43 such that the outer cover 101 moves from a closed state to an open side.

According to such a configuration, for strong double feed that is not able to be eliminated by the pressing of the separation pad 34, it is possible to prompt the removal of double feed sheets by a user by opening the outer cover 101.

### Other Embodiments

In the aforementioned embodiment, the separation pad 34 is allowed to be pressed against the subsequent second sheet S2; however, the technology of the present disclosure is not limited thereto and the separation pad 34 may be allowed to be pressed against the first sheet S1.

In the aforementioned embodiment, the document conveying device 100 has been described as an example of a sheet conveying device; however, the technology of the present disclosure is not limited thereto. The sheet conveying device, for example, may also be provided in the sheet conveyance path T that conveys the printing sheet P.

What is claimed is:

1. A sheet conveying device comprising:
a conveying mechanism configured to convey sheets along a sheet conveyance path;
a double feed detection sensor provided at a double feed detection position set in the sheet conveyance path and configured to output a signal for detecting double feeding of the sheets;
a double feed determination unit configured to determine whether the double feeding of the sheets is occurring based on the signal of the double feed detection sensor;
a double feed state determination unit configured to determine whether, when the double feed determination unit determines that the double feeding is occurring, a first sheet and a second sheet being double-fed are in a full double feed state in which the first sheet and the second sheet are conveyed while overlapping each other from distal end parts of the first sheet and the second sheet in a conveyance direction or a partial double feed state in which the second sheet is conveyed while overlapping a rear part of the first sheet than the distal end part of the first sheet in the conveyance direction; and
a control unit configured to stop an operation of the conveying mechanism when the double feed state determination unit determines that the first sheet and the second sheet are in the full double feed state, and perform double feed elimination control for eliminating the double feeding of the first sheet and the second sheet while continuing the operation of the conveying mechanism when the double feed state determination unit determines that the first sheet and the second sheet are in the partial double feed state.

2. The sheet conveying device of claim 1, wherein the sheet conveying device comprises:
a separation member provided on a downstream side in the conveyance direction with respect to the double feed detection sensor and movably disposed between a separation position where the separation member contacts with any one of the first sheet and the second sheet being double-fed and a standby position where the separation member is retracted from the separation position and does not contact with both the sheets; and
a driving actuator configured to drive the separation member between the separation position and the standby position,
wherein the double feed elimination control is control in which the separation member at the standby position is moved to the separation position so as to be brought into contact with one sheet of the sheets and frictional force is applied to the one sheet from the separation member, so that a remaining sheet is separated from the one sheet and is conveyed.

3. The sheet conveying device of claim 1, further comprising:
an openable and closable outer cover configured to cover the sheet conveyance path; and
a cover driving unit configured to be able to drive the outer cover from a closed state to an open side,
wherein the control unit is configured to drive the cover driving unit such that the outer cover moves from the closed state to the open side when the double feed state determination unit determines that the first sheet and the second sheet are in the full double feed state.

4. An image reading device comprising the sheet conveying device of claim 1.
